(19) United States
(12) Patent Application Publication
(10) Pub. No.: US 2011/0190975 A1
(43) Pub. Date: Aug. 4, 2011

(54) METHOD AND DEVICE FOR DETECTING LOSS OF PRESSURE IN A TIRE

(75) Inventors: Sylvain Hourlier, Arpaion (FR); Bruno Serra, Etampes (FR)

(73) Assignee: Renault s.a.s., Boulogne-Billancourt (FR)

(21) Appl. No.: 13/001,757

(22) PCT Filed: Jun. 15, 2009
(86) PCT No.: PCT/FR2009/051126

§ 371 Date: Mar. 1, 2011

(30) Foreign Application Priority Data
Jun. 30, 2008 (FR) 0803666

(51) Int. Cl. G06F 19/00

(52) U.S. Cl. 701/29

(57) ABSTRACT

A method for monitoring the pressure in a tire of a vehicle wheel, including measuring the wheel speed, to detect a loss of pressure using inexpensive components, and to produce a highly robust diagnosis due in particular to: calculating a first sum of the speeds of the left front wheel and right rear wheel and a second sum of the speeds of the right front wheel and left rear wheel, calculating a difference equal to the first sum minus the second sum, and comparing an absolute value of the difference with a threshold, such that an absolute value greater than the threshold denotes detection of a loss of pressure in one of the tires.

The invention relates to the field of motor vehicles. The present invention relates more particularly to the detection of pressure loss in vehicle tires.

Systems for checking pressures in tires are, for example, based on pressure sensors, each tire being equipped with a pressure sensor producing data representative of the pressure in the tire, such information being collected and processed by a central device. A pressure sensor is, for example, arranged in place of the tire pressure valve. Such equipment of the vehicle with the central device for recovering and processing information and a pressure sensor for each wheel is, however, costly.

The patent application US 2007/061100 teaches of cross-use of a WRA (wheel radius analysis) component and of a WVA (wheel vibration analysis) component. These two components receive information produced by wheel angular speed sensors and produce data relating to the diameters of the wheels and to the vibration frequencies of the wheels to be combined and to determine a pressure difference in the tires. The method taught is, however, complex and requires electronic components that are accurate and have sufficient computation power to be able to obtain the pressure difference results.

There is therefore a need to simplify the calculation method and the corresponding necessary electronic system in order to supply, on the one hand, an analysis result of greater robustness and, on the other hand, an inexpensive electronic system for monitoring the pressure of the tires.

The object of the present invention is therefore to overcome one or more of the prior art drawbacks, by proposing a method for monitoring pressure in the tires that makes it possible to detect a pressure loss using inexpensive components and producing an extremely robust diagnosis.

This objective is achieved by virtue of a method for monitoring the pressure of the tires of the wheels of a vehicle comprising a step of measuring, using speed sensors, rotation speeds of the vehicle wheels including a speed of the front left wheel, a speed of the front right wheel, a speed of the rear right wheel and a speed of the rear left wheel, characterized in that it comprises:
a step of calculating and storing a first sum of the speed of the front left wheel and of the speed of the rear right wheel and of calculating and storing a second sum of the speed of the front right wheel and of the speed of the rear left wheel,
a step of calculating and storing a first difference corresponding to the first sum from which the second sum is subtracted,
a step of comparing an absolute value of the first difference with a stored first maximum threshold representative, if the first threshold is exceeded, of a drop in pressure in one of the tires.

According to another particular feature, each calculated sum is weighted by a coefficient of ½ and corresponds to an average value.

According to another particular feature, the step of comparing the absolute value of the first difference with the first threshold is followed, if the first threshold is exceeded, by a step of sending a warning signal indicating a pressure drop in one of the tires.

According to another particular feature, the method comprises:
a step of checking that a position and a speed of a steering wheel for guiding the vehicle, determined by a steering wheel position sensor, correspond to a stable direction of the vehicle directed straight ahead,
a step of calculating and storing a third sum of the speed of the front left wheel and of the speed of the rear left wheel and of calculating and storing a fourth sum of the speed of the front right wheel and of the speed of the rear right wheel,
a step of calculating and storing a second difference corresponding to the third sum from which the fourth sum is subtracted.

According to another particular feature, the method is followed by a step of comparing the absolute value of the second difference with a stored second maximum threshold representative, if the second threshold is exceeded, of a confirmation of the pressure drop in one of the tires when the vehicle is directed straight ahead.

According to another particular feature, the method comprises a step of determining the wheel whose tire has a pressure drop, using a stored table associating each of the wheels with a unique combination of the signs of the first and second differences such that:
the front right wheel is associated with a positive sign of the first difference and with a positive sign of the second difference,
the rear right wheel is associated with a negative sign of the first difference and with a positive sign of the second difference,
the rear left wheel is associated with a positive sign of the first difference and with a negative sign of the second difference,
the front left wheel is associated with a negative sign of the first difference and with a negative sign of the second difference.

According to another particular feature, each wheel being equipped with a pressure sensor, the method is followed by a step of checking the pressure drop in the wheel determined by monitoring the pressure sensor of that wheel.

Pressure sensors could, for example, be used to obtain more accurate and even numbered information of the pressure value or of the pressure drop in the tire or to obtain a difference between the pressures of two tires.

According to another particular feature, the method is followed by a step of sending a warning signal indicating a pressure drop in the determined wheel.

According to another particular feature, the method is preceded by a step of calibrating the speed sensors of the vehicle wheels.

Another object of the present invention is to propose a device for monitoring pressure in the tires that makes it possible to detect a pressure drop using inexpensive components and produces an extremely robust diagnosis.

This objective is achieved by virtue of a device for monitoring the pressure of the tires of vehicle wheels comprising speed sensors measuring rotation speeds of the vehicle wheels, including a speed of the front left wheel, a speed of the front right wheel, a speed of the rear right wheel and a speed of the rear left wheel, characterized in that it comprises:
a module for calculating and storing a first sum of the speed of the front left wheel and of the speed of the rear right wheel and of calculating and storing a second sum of the speed of the front right wheel and of the speed of the rear left wheel,
a module for calculating and storing a first difference corresponding to the first sum from which the second sum is subtracted,
a module for comparing an absolute value of the first difference with a stored first maximum threshold representative, if the first threshold is exceeded, of a pressure drop in one of the tires.

According to another particular feature, the device comprises:
a module for checking that a position and a speed of a steering wheel for guiding the vehicle, determined by a steering wheel position sensor, correspond to a stable direction of the vehicle directed straight ahead,
a module for calculating and storing a third sum of the speed of the front left wheel and of the speed of the rear left wheel and of calculating and storing a fourth sum of the speed of the front right wheel and of the speed of the rear right wheel,
a module for calculating and storing a second difference corresponding to the third sum from which the fourth sum is subtracted,
a module for determining the wheel whose tire has a pressure drop, using a stored table associating each of the wheels with a unique combination of the signs of the first and second differences, such that:
the front right wheel is associated with a positive sign of the first difference and with a positive sign of the second difference,
the rear right wheel is associated with a negative sign of the first difference and with a positive sign of the second difference,
the rear left wheel is associated with a positive sign of the first difference and with a negative sign of the second difference,
the front left wheel is associated with a negative sign of the first difference and with a negative sign of the second difference.

The invention, its features and its advantages will become more clearly apparent on reading the description given with reference to the figures given as nonlimiting examples and referenced hereinbelow:

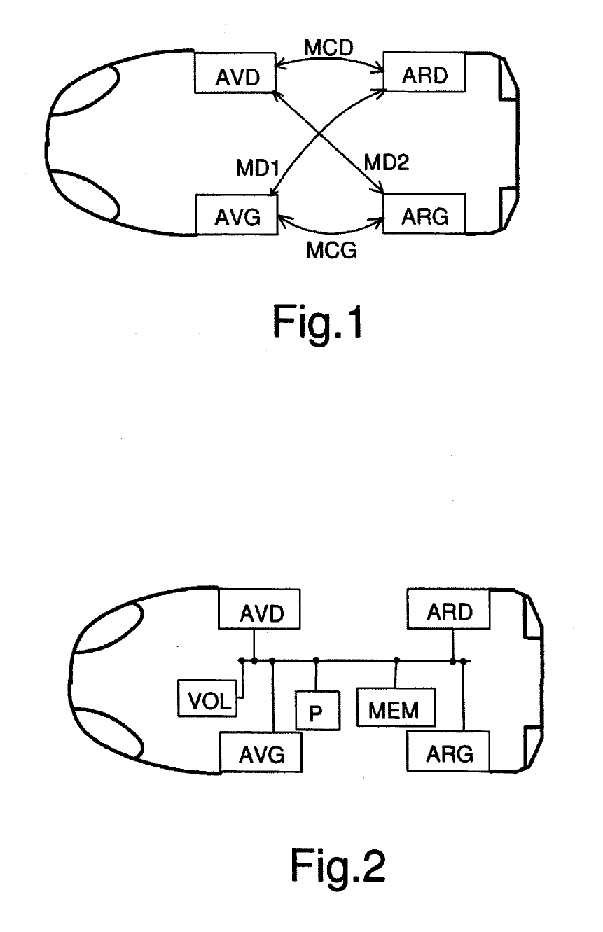

FIG. 1 represents a diagram of measured speed combinations according to the present invention,

FIG. 2 represents an exemplary hardware architecture supporting the method according to the present invention,

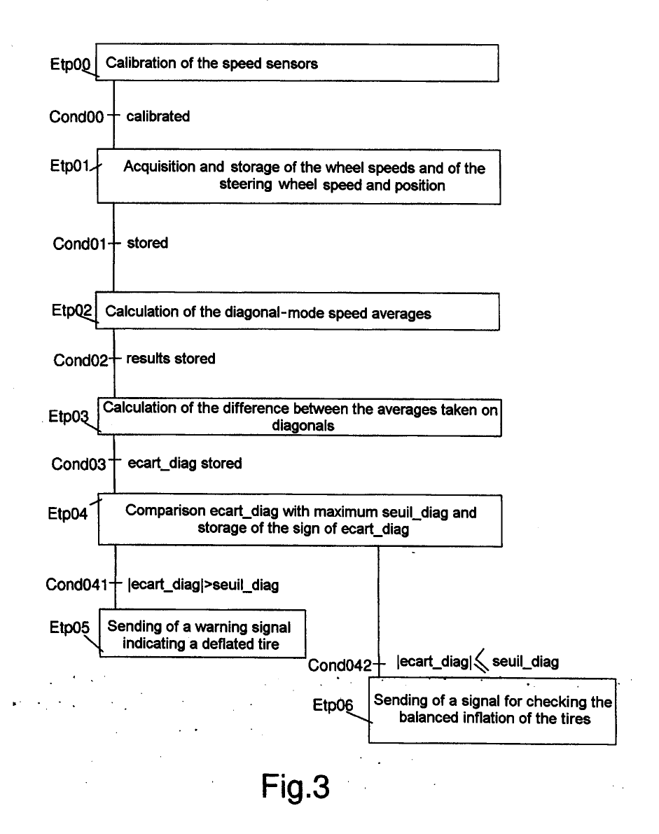

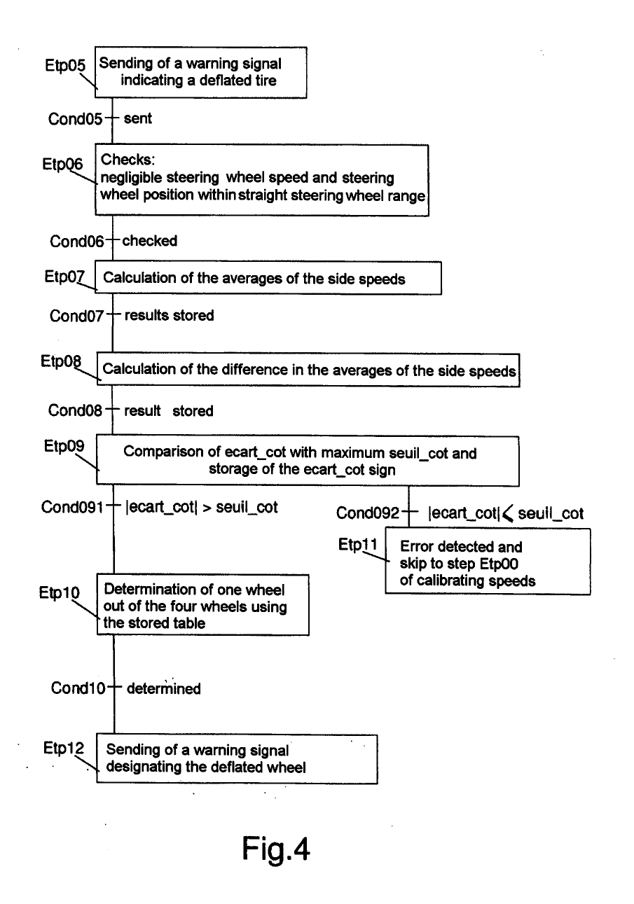

FIGS. 3 and 4 represent an exemplary monitoring method according to the present invention;

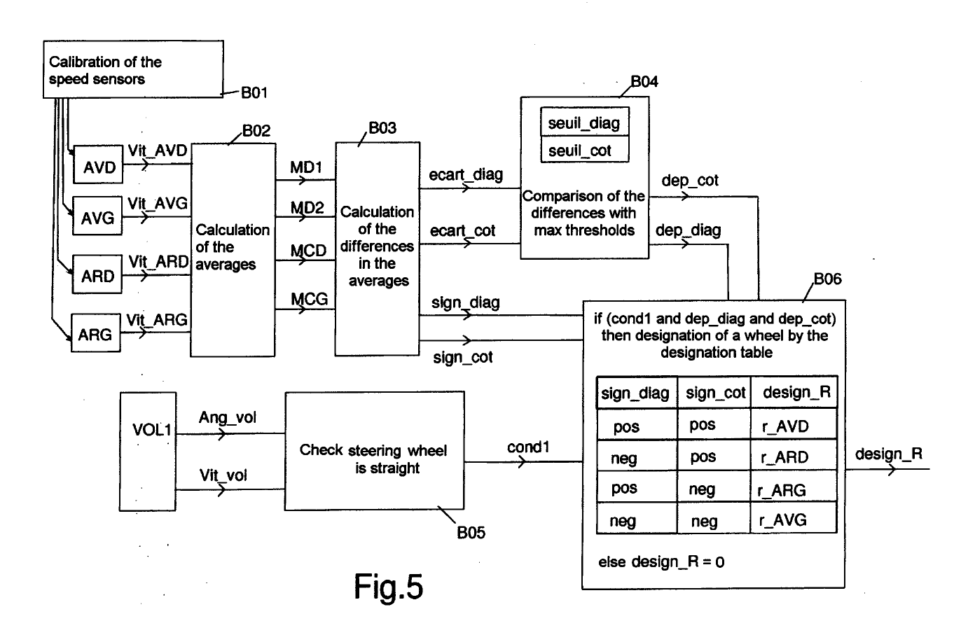

FIG. 5 represents an exemplary configuration of a monitoring device according to the present invention.

The invention will now be described with reference to the abovementioned figures.
A motor vehicle is, for example, equipped with:
a rotation speed sensor (AVD) for the front right wheel,
a rotation speed sensor (AVG) for the front left wheel,
a rotation speed sensor (ARD) for the rear right wheel and
a rotation speed sensor (ARG) for the rear left wheel.

In a nonlimiting manner, these rotation speed sensors may be implemented by the speed sensors of an antilock braking system, also designated ABS. Other types of angular speed sensors for each wheel can also be used.

The speed sensors produce, for example, data (Vit_AVD, Vit_AVG, Vit_ARD, Vit_ARG) representative of the angular speed of each wheel or data representative of a duration to cover a determined angular distance for each wheel, from which data the wheel rotation speeds are, for example, calculated. The angular speed sensors for example transmit the data they produce, via communication links, to a device for processing these data comprising a component (P) for calculating and for reading and writing in a memory (MEM). The wheel speed data can, for example, be processed by the ECU (engine control unit) of the vehicle running a stored program for processing wheel speed data. In a nonlimiting manner, the memory (MEM) comprises a program storage area, a temporary calculation data storage area and an area for storing variables or results.

Active modules are, for example, each implemented by a program stored and run by the processing component to produce one or more determined functions. It will be understood that the processing programs are provided with at least one subroutine which can be used to store all the intermediate results, obtained successively during the processing, for example using storage tables. Various calculation algorithms are respectively used by calculation modules arranged to recover the appropriate information (portions of data or of signals currently being processed, results of previous operations, etc.).

The device for monitoring pressure in the tires for example produces data (dep_diag) representative of the detection of a pressure drop in one of the wheel tires or data (design_R) representative of the designation of a determined wheel whose tire has a pressure drop.

An exemplary monitoring method will now be described. In a nonlimiting manner, the step (Etp00) of calibrating the speed sensors is, for example, performed before a speed measuring step. A module (B01) for calibrating the speed sensors transmits, for example, in this step (Etp00) commands to initialize the speed sensors (AVD, AVG, ARD, ARG). Each wheel in fact has a tire mounting for which the size of the sidewalls and the diameter of each wheel are identical when the tires are new and inflated to the same pressure. The calibration step makes it possible, for example, to take into account the wear of the tires or the pressure differences between the front wheel train and the rear wheel train. This calibration operation may, for example, be performed after adjusting the pressure of the tires of the vehicle and by positioning the vehicle on a conveyor belt or by launching an initialization during a straight-line travel. Taking the wear of the tires into account makes it possible notably not to wrongly detect a pressure difference.

After the sensors have been calibrated (Cond00), a subsequent step (Etp01) of acquiring and storing the wheel speeds, the speed of the steering wheel and the position of the steering wheel, is, for example, performed. Data (Vit_AVD, Vit_AVG, Vit_ARD, Vit_ARG) produced by the speed sensors are for example stored in memory or transmitted to a module (B02) that uses these measured speeds to calculate average speeds. Data produced by a position sensor (VOL1) for the steering wheel, representative of the angular position (Ang_vol) of the steering wheel and of the angular speed (Vit_vol) of the steering wheel, are for example stored in memory or transmitted to a module (B05) for checking the position and the speed of the steering wheel.

After the measured parameters have been stored (Cond01), a subsequent step (Etp02) of calculating the average (MD1) of the speeds (Vit_AVG, Vit_ARD) of the front left and rear right wheels and of calculating the average (MD2) of the speeds (Vit_AVD, Vit_ARG) of the front right and rear left wheels, is for example executed. These averages, corresponding to a sum weighted by ½, are notably represented as diagonal in the diagram of FIG. 1. A module (B02) for calculating averages for example calculates these averages, data (MD1, MD2) representative of these averages taken on diagonals, are for example stored in memory or transmitted to a module (B03) for processing the averages. The following equalities between stored data are for example checked:

MD1=(Vit_AVG+Vit_{—}ARD)/2

MD2=(Vit_{—}AVD+Vit_{—}ARG)/2

After the averages taken on diagonals have been stored (Cond02), a step (Etp03) of calculating the difference (ecart_diag) between the averages taken on diagonals is, for example, performed. A module (B03) for calculating the differences in the averages performs, for example, a subtraction between the average (MD1) of the speeds of the front left and rear right wheels and the average (MD2) of the speeds of the front right and rear left wheels, corresponding to a first difference (ecart_diag). The following equalities between stored data are, for example, checked:

ecart_diag=MD1−MD2

The stored data representative of the first calculated difference are representative of an absolute value and of a sign of the first calculated difference. A variable (sign_diag) representative of the sign of the first calculated difference is, for example, initialized.

After the first difference has been stored (Cond03), a subsequent step (Etp04) of comparing the absolute value of the first difference with a first maximum threshold (seuil_diag) is, for example, performed by a module (B04) for comparing the differences with stored maximum thresholds (seuil_diag, seuil_cot). This module (B04) for example calculates the absolute value of the first difference (ecart_diag) and compares this absolute value with the first determined threshold (seuil_diag) to update a variable (dep_diag) representative of the exceeding of the difference threshold in the averages taken on diagonals. This variable is, for example, set to zero if the threshold is not exceeded or is set to a non-zero value corresponding to the value by which the maximum threshold is exceeded.

If (Cond041) the absolute value of the first difference (ecart_diag) is greater than the first threshold (seuil_diag), a subsequent step (Etp05) of sending a warning signal indicating a deflated tire is for example transmitted to a warning management module or to another determined address. This state corresponds for example to a non-zero value of the output variable (dep_diag) representative of a threshold being exceeded for the difference in the averages taken on diagonals, the value of this variable (dep_diag) for example being read and advantageously representing an intensity or a severity of the detected defect.

If (Cond042) the absolute value of the first difference (ecart_diag) is less than or equal to the first threshold (seuil_diag), a subsequent step (Etp06) of sending a successful check signal concerning the balancing of the tires is, for example, performed.

Thus, the system determines, from the end of the step (Etp04) of comparing the absolute value of the first difference with the first maximum threshold, whether a pressure loss or a puncture has occurred in one of the four tires. The system can, for example, transmit an alarm signal, indicated on the driver's dashboard. Advantageously, these steps (Etp00, Etp01, Etp02, Etp03, Etp04, Etp05, Etp06) can, for example, be programmed just in the ECU (engine control unit) in order to save on the available memory resources and limit the resources needed to install the program. The calculation of the difference between the averages of the wheel speeds taken in diagonal pairs makes it possible in fact to determine on its own whether one of the tires has a pressure defect. These averages or equivalent weighted sums, over speeds taken in diagonals, can advantageously be calculated and remain valid when the vehicle is in a straight line or on a curve. Although the calculation on the speeds in diagonals remains valid in curved trajectories, these averages can be calculated, in a nonlimiting manner, when the vehicle is in a straight line to avoid any measurement errors due to tire slip. When there is no pressure drop, the averages of the speeds taken in diagonals are in fact identical, to within a tolerance margin, regardless of the trajectory.

In a nonlimiting manner, after (Cond05) the warning signal indicating a detected pressure drop has been sent, a subsequent step (Etp06) of checking the position and the speed of the steering wheel corresponding to a stable and perfectly straight direction of the vehicle is checked. The datum (Ang_vol) representative of the position of the steering wheel is, for example, processed by the module (B05) for checking the position of the steering wheel, relative to a value range corresponding to a straight steering wheel, to within a tolerance margin. The datum (Vit_vol) is for example processed according to a range of values corresponding to a zero steering wheel speed, to within a tolerance margin. A successful check is for example indicated when each measured parameter falls within the associated test range. If the position checking processing operations are satisfied, the module (B05) for example sets an output variable (cond1) to “1”, and otherwise to “0”.

The second difference between the averages of the right speeds and the left averages is in fact calculated when the car is in a straight line to avoid pressure differences due to wheel accelerations or locks or centrifugal-type forces. The position sensor (VOL1) monitoring the position of the steering wheel held by the driver makes it possible to check that the car is indeed in a straight line. Calibrations are for example used to adjust the sensitivity of the two detection functions. Other car stability sensors could also be used.

In a nonlimiting manner, a module for checking a stable position of the steering wheel and in a perfectly straight position, could also determine the output variable (cond1) according to the measured speeds. A turned position or a position of the vehicle turning can, for example, be detected by the second difference exceeding a third significant determined threshold. A check may also consist of a comparison of the overall speed at the gearbox output to the diagonal and side averages, the overall speed having to be monitored as greater, in order to take into account the deflection of the tire without requiring the use of the steering wheel position sensor. The overall speed could also be reconstructed from information originating from the ABS sensors, the surest value being desirable.

Checking a position of the vehicle going straight ahead or not being in a position involving overpressures or pressure drops in certain tires thus makes it possible to further enhance the robustness of the pressure drop monitoring functions.

After (Cond06) checking a stable and straight ahead position of the vehicle, a subsequent step (Etp07) of calculating the average (MCD) of the speeds (Vit_AVD, Vit_ARD) of the wheels taken on the right and of the average (MCG) of the speeds (Vit_AVG, Vit_ARG) of the wheels taken on the left, is for example performed by the module (B02) for calculating the averages. The following equalities between stored data are, for example, checked:

MCD=(Vit_{—}AVD+Vit_{—}ARD)/2

MCG=(Vit_{—}AVG+Vit_{—}ARG)/2

After (cond07) these averages have been stored, a subsequent step (Etp08) of calculating the second difference (ecart_cot) between the average (MCD) of the speeds (Vit_AVD, Vit_ARD) of the wheels taken on the right and of the average (MCG) of the speeds (Vit_AVG, Vit_ARG) of the wheels taken on the left, is for example performed by the module (B03) for calculating the differences between averages. The module (B03) for example performs the calculation of the average of the speeds taken on the left from which the average of the speeds taken on the right is subtracted. The following equalities between stored data are, for example, checked:

ecart_cot=MCG−MCD

This difference datum (ecart_cot) notably corresponds to a positive or negative sign and to an absolute value. A variable (sign_cot) corresponding to the sign of this difference is, for example, initialized or updated.

After (Cond08) the second difference (ecart_cot) has been stored, a subsequent step (Etp09) of comparison between the second difference and a stored second maximum threshold (seuil_cot) is for example performed by the module (B04) for comparing the differences with their associated maximum threshold. The absolute value of the second difference is, for example, compared to the associated maximum threshold (seuil_cot) to determine whether or not the threshold has been exceeded. A variable (dep_cot) is for example set to “0” if the threshold is not exceeded and set to a non-zero value corresponding to the severity of the overshoot if the second maximum threshold is exceeded.

If (Cond092) no overshoot is detected, an overshoot having been detected previously and the non-curved trajectory having been checked, a subsequent error detected step (Etp11) results for example in a skip to the step (Etp00) of calibrating the speed sensors.

If (Cond091) an overshoot is detected, a subsequent step (Etp10) of determining the wheel that has a pressure drop out of the four wheels is performed. This determination is, for example, performed using a stored table which associates with each wheel (r_AVD, r_ARD, r_ARG, r_AVG) a unique combination of the signs of the two differences calculated previously:
the sign (sign_diag) of the first difference (ecart_diag) in the averages of the speeds taken on diagonals and

the sign (sign_cot) of the second difference (ecart_cot) in the averages of the speeds taken on the right or on the left.

As represented in FIG. 5, the front right wheel (r_AVD) is for example associated with a positive sign (pos) of the first difference (ecart_diag) and with a positive sign (pos) of the second difference (ecart_cot). The rear right wheel (r_ARD) is for example associated with a negative sign (neg) of the first difference (ecart_diag) and with a positive sign (pos) of the second difference (ecart_cot). The rear left wheel (r_ARG) is for example associated with a positive sign (pos) of the first difference (ecart_diag) and with a negative sign (neg) of the second difference (ecart_cot). The front left wheel (r_AVG) is for example associated with a negative sign (neg) of the first difference (ecart_diag) and with a negative sign (neg) of the second difference (ecart_cot).

The table is for example stored by a module (B06) for designating the wheel that has a pressure drop. This module (B06) for example sets an output variable (design_R) to a value corresponding to one of the wheels or to zero if the designation conditions are not satisfied. In a nonlimiting manner, the module (B06) for designating the wheel that has a pressure drop for example performs a preliminary test prior to reading the stored table. This preliminary test for example involves checking that the steering wheel position variable and the threshold overshoot variables are all nonzero and, if not, sets the output variable (design_R) to zero. If the designation conditions are satisfied, the wheel that has a pressure drop is determined by reading the table and by testing the signs of the calculated differences, the output variable (design_R) then taking one of the values (r_AVD, r_ARD, r_ARG, r_AVG) designating wheels in the table.

After (Cond10) a wheel that has a pressure drop has been determined, a step (Etp12) of sending a warning signal designating the wheel with a pressure drop is, for example, performed.

According to another exemplary embodiment, the steps (Etp07, Etp02) of calculating speed averages could be performed at the same time. The steps (Etp08, Etp03) of calculating the differences could also be performed at the same time and the steps (Etp09, Etp04) of comparing the differences with their maximum threshold could also be performed at the same time.

In a nonlimiting manner, a variable representative of the speed of the vehicle produced by a speed sensor may be taken into account by one or more of the modules, for example to disable the calculations in case of a zero or excessively low vehicle speed.

In a nonlimiting manner, the detection of the threshold overshoots by the calculated differences results for example in a switchover to a warning state. The warning state is for example canceled when a determined time delay has elapsed after the defect or warning has disappeared. The duration of the time delay is, for example, initialized according to the seriousness of the detected defect. Until the defect has disappeared, the associated time delay is, for example, reinitialized and the warning state is maintained. Then, when the defect has disappeared and the time delay has elapsed, the warning state is for example canceled.

In a nonlimiting manner, the method of detecting pressure loss could also be used in parallel with a method of directly measuring the pressure in the tires or a complex and sensitive method of indirectly estimating pressure differences, in order to validate the system operating in parallel.

It should be clear to those skilled in the art that the present invention allows for embodiments in numerous other specific forms without departing from the scope of the invention as claimed. Consequently, the present embodiments should be considered as illustrative but may be modified within the field defined by the scope of the appended claims.

1-11. (canceled)

12. A method for monitoring pressure of tires of wheels of a vehicle, comprising:
measuring, using speed sensors, rotation speeds of the vehicle wheels including a speed of a front left wheel, a speed of a front right wheel, a speed of a rear right wheel and a speed of a rear left wheel;
calculating and storing a first sum of the speed of the front left wheel and of the speed of the rear right wheel, and calculating and storing a second sum of the speed of the front right wheel and of the speed of the rear left wheel;
calculating and storing a first difference corresponding to the first sum from which the second sum is subtracted; and
comparing an absolute value of the first difference with a stored first maximum threshold representative, if the first threshold is exceeded, of a drop in pressure in one of the tires.

13. The method as claimed in claim 12, wherein each calculated sum is weighted by a coefficient of ½ and corresponds to an average value.

14. The method as claimed in claim 12, wherein the comparing the absolute value of the first difference with the first threshold is followed, if the first threshold is exceeded, by sending a warning signal indicating a pressure drop in one of the tires.

15. The method as claimed in claim 12, further comprising:
checking that a position and a speed of a steering wheel for guiding the vehicle, determined by a steering wheel position sensor, correspond to a stable direction of the vehicle directed straight ahead;
calculating and storing a third sum of the speed of the front left wheel and of the speed of the rear left wheel, and calculating and storing a fourth sum of the speed of the front right wheel and of the speed of the rear right wheel; and
calculating and storing a second difference corresponding to the third sum from which the fourth sum is subtracted.

16. The method as claimed in claim 15, further comprising comparing the absolute value of the second difference with a stored second maximum threshold representative, if the second threshold is exceeded, of a confirmation of the pressure drop in one of the tires when the vehicle is directed straight ahead.

17. The method as claimed in claim 15, further comprising determining the wheel whose tire has a pressure drop, using a stored table associating each of the wheels with a unique combination of the signs of the first and second differences such that:
the front right wheel is associated with a positive sign of the first difference and with a positive sign of the second difference,
the rear right wheel is associated with a negative sign of the first difference and with a positive sign of the second difference,
the rear left wheel is associated with a positive sign of the first difference and with a negative sign of the second difference,
the front left wheel is associated with a negative sign of the first difference and with a negative sign of the second difference.

18. The method as claimed in claim 17, wherein, each wheel including a pressure sensor, the method further comprising checking the pressure drop in the wheel determined by monitoring the pressure sensor of that wheel.

19. The method as claimed in claim 17, further comprising sending a warning signal indicating a pressure drop in the determined wheel.

20. The method as claimed in claim 12, further comprising calibrating the speed sensors of the vehicle wheels.

21. A device for monitoring pressure of tires of vehicle wheels including speed sensors measuring rotation speeds of the vehicle wheels, including a speed of a front left wheel, a speed of a front right wheel, a speed of a rear right wheel and a speed of a rear left wheel, the device comprising:
a module that calculates and stores a first sum of the speed of the front left wheel and of the speed of the rear right wheel, and calculates and stores a second sum of the speed of the front right wheel and of the speed of the rear left wheel,
a module that calculates and stores a first difference corresponding to the first sum from which the second sum is subtracted;
a module that compares an absolute value of the first difference with a stored first maximum threshold representative, if the first threshold is exceeded, of a pressure drop in one of the tires.

22. The device as claimed in claim 21, further comprising:
a module that checks that a position and a speed of a steering wheel for guiding the vehicle, determined by a steering wheel position sensor, correspond to a stable direction of the vehicle directed straight ahead;
a module that calculates and stores a third sum of the speed of the front left wheel and of the speed of the rear left wheel, and calculates and stores a fourth sum of the speed of the front right wheel and of the speed of the rear right wheel;
a module that calculates and stores a second difference corresponding to the third sum from which the fourth sum is subtracted;
a module that determines the wheel whose tire has a pressure drop, using a stored table associating each of the wheels with a unique combination of the signs of the first and second differences, such that:
the front right wheel is associated with a positive sign of the first difference and with a positive sign of the second difference,
the rear right wheel is associated with a negative sign of the first difference and with a positive sign of the second difference,
the rear left wheel is associated with a positive sign of the first difference and with a negative sign of the second difference,
the front left wheel is associated with a negative sign of the first difference and with a negative sign of the second difference.
